(19) United States
(12) Patent Application Publication
(10) Pub. No.: US 2022/0289573 A1
(43) Pub. Date: Sep. 15, 2022

(54) CONTINUOUS PROCESS FOR MANUFACTURING HIERARCHICALLY POROUS CARBON MATERIAL

(71) Applicant: ThruPore Technologies, Inc, New Castle, DE (US)

(72) Inventors: Franchessa Sayler, Bear, DE (US); Trupti Kotbagi, Birmingham, AL (US); John Brown, Birmingham, AL (US); Kyle Leibenguth, Addis, LA (US)

(73) Assignee: ThruPore Technologies, Inc, New Castle, DE (US)

(21) Appl. No.: 17/637,785

(22) PCT Filed: Sep. 8, 2020
(86) PCT No.: PCT/US2020/049756

§ 371 Date: Feb. 23, 2022

Related U.S. Application Data
(60) Provisional application No. 62/897,618, filed on Sep. 9, 2019.

(51) Int. Cl. C01B 32/05; B29C 48/00; B29C 48/80

(52) U.S. Cl. CPC C01B 32/05; B29C 48/022; B29C 48/802; C01P 2004/03

(57) ABSTRACT

Continuous processes for the manufacture of porous carbon materials are disclosed. The process includes the reaction of a self-assembling polymeric mixture, followed by drying and extrusion of the cured, semi-dry polymeric gel extrudate prior to pyrolysis. Also disclosed are porous carbon materials, such as porous carbon monoliths, produced by these processes. In particular, hierarchically porous carbon materials for use as a catalyst support or for the adsorption of gas and other substances that are manufactured by these processes are also disclosed.

### CROSS REFERENCE TO RELATED APPLICATIONS

This claims the benefit of U.S. Provisional Application No. 62/897,618, filed Sep. 9, 2019, the entire contents of which are incorporated by reference herein.

### FIELD OF THE INVENTION

The present invention generally relates to porous carbon materials and methods of making porous carbon materials. Specifically, the invention relates to a continuous process for manufacturing hierarchically porous carbon materials.

### BACKGROUND OF THE INVENTION

Porous carbon materials have many applications across various fields and industries. These materials are used to capture or store gases, such as methane, carbon dioxide, or hydrogen; to purify drinking water or air; for metal extraction or purification; in sewage treatment; as a treatment for poisoning, diarrhea, or overdoses; as a catalyst support material; and many others. Furthermore, porous carbon materials can also be found in filters for gas masks, respirators, or in compressed air, and are used in the power industry for the selective capture of carbon dioxide (CO2 sequestration) from power plant flue gas. Typically, the carbon material is processed, or activated, for improved adsorption, functionalities, or to facilitate chemical reactions. The activation process can involve chemical reagents (e.g., using mild or strong acid or base) or activation using gases (e.g., steam activation or ammonia (NH₃) activation).

As many users may desire specific shapes or dimensions, there exists a need to mold, shape, sieve or cast these materials (e.g. “monolith”). For these highly porous materials, any molding or shaping technique used in the manufacturing process must ensure that the porous structure of the material is retained. Indeed, machining techniques designed to yield a specific form factor may result in alteration of the microstructure and reduce the efficacy of the material. To date, a continuous, safe process for the manufacture of hierarchically porous carbon monoliths has remained elusive.

Thus, there remains a need in the art for an efficient, automated, continuous, and safe manufacturing process for producing porous carbon materials.

### SUMMARY OF THE INVENTION

Described herein are methods to produce hierarchically porous carbon materials. In particular, disclosed herein is a continuous process for manufacturing hierarchically porous carbon materials and comprises a reaction step, a drying step, a sizing and forming step, and a pyrolysis step. It is desirable that the process be automated such that once the feedstock composition is combined, the materials are then reacted, cured and dried, sized and formed, and pyrolyzed as a continuous process. The process provided herein produces hierarchically porous carbon monoliths with the desirable portion of mesopores to macropores in a safe and efficient manner including forming the material into the desired shapes or dimensions.

One aspect of the invention features a method of producing a porous carbon material that includes the steps of (a) providing carbon in the form of a phase-homogeneous polymeric mixture; (b) reacting the phase-homogeneous polymeric mixture at a first temperature in the range from about 40° C. to about 130° C. and for a first period of time from about 1 minute to about 60 minutes to allow the phase-homogeneous polymeric mixture to self-assemble to form a polymeric gel; (c) drying the polymeric gel at a second temperature in the range from about 40° C. to about 140° C. and for a second period of time from about 1 minute to about 12 hours to produce a dried polymeric gel; (d) shaping the dried polymeric gel to produce a shaped polymeric gel; and (e) pyrolyzing the shaped polymeric gel at a third temperature in the range from about 500° C. to about 1,300° C. and for a third period of time from about 10 minutes to about 12 hours to produce the porous carbon material. In preferred embodiments, steps (b) through (d) are performed as an automatic, continuous process; more preferably, steps (b) through (e) are performed as an automatic, continuous process. In some embodiments, a mixing step is performed prior to reacting the phase-homogeneous polymeric material, which comprises mixing an organic polymer composition to produce the phase-homogeneous polymeric mixture. This additional mixing step can also be included in an automatic, continuous process that includes steps (a) through (c) or steps (a) through (d). In other embodiments, the method includes a first temperature from about 60° C. to about 100° C. with a first period of time from about 1 minute to about 10 minutes, a second temperature from about 75° C. to about 140° C. with a second period of time from about 1 minute to about 10 minutes, and/or a third temperature from about 600° C. to about 1,000° C. In a particular embodiment, the first temperature is from about 75° C. to about 85° C., and the second temperature is from about 100° C. to about 130° C. In particular embodiments, the porous carbon material produced by the methods described herein is a hierarchical porous carbon material.

In some embodiments, the method includes reacting the phase-homogeneous polymeric mixture in a reactor, such as a plug-flow reactor or a tube-in-tube heat exchanger. In other embodiments, the reacting step further comprises the addition of an initiator compound. In some aspects, the initiator is an aldehyde, such as formaldehyde. In some versions of the present method, the initiator compound can be added to the reactor concurrently with the addition of the phase-homogeneous polymeric mixture.

In some embodiments, the phase-homogeneous polymeric mixture comprises a self-assembling thermoset polymer composition. In other embodiments, the self-assembling thermoset polymer composition comprises an amine, an aldehyde, and a phenolic compound. In yet other embodiments, the self-assembling thermoset polymer composition further comprises a surfactant, a pore-forming solid, a solvent, or any combination thereof. Particular amines suitable for use herein may include a primary amine, such as 1,6-diaminohexane or lysine. In some versions of the method, the aldehyde is formaldehyde, trioxane, butyraldehyde, or benzaldehyde. Suitable phenolic compounds include, but are not limited to benzenediols, such as 1,3-benzenediol or phenol.

In one embodiment, the shaping step further comprises injection molding, pour molding, casting, extrusion, or extrusion-spheronization. For instance, the shaping step may include an extruder for extruding the dried polymeric gel. Suitable extruders include, but are not limited to, screw extruders, food extruders, sieve extruders, basket extruders, roll extruders, ram extruders, pressure extruders, hydraulic extruders, or devolatilizing extruders. For instance, in a particular aspect, the extruder is a devolatilizing extruder configured to dry the polymeric gel and to extrude the dried polymeric gel.

Another aspect of the invention features a system for manufacturing hierarchical porous carbon material. This system includes (a) a reactor, such as a pipe, plug-flow reactor, or tube-in-tube heat exchanger, that is configured for reacting a self-assembling thermoset polymeric mixture to produce a polymeric gel; (b) a drying device configured for drying the polymeric gel to produce a dried polymeric gel; (c) an extruder configured for extruding the dried polymeric gel to produce an extruded polymeric gel; and (d) a pyrolysis device configured for pyrolyzing the extruded polymeric gel to produce a hierarchical porous carbon material.

In some embodiments, the system also includes a mixing tank configured for producing a self-assembling thermoset polymeric mixture containing carbon and transporting the self-assembling thermoset polymeric mixture to the reactor. In other embodiments, the reactor comprises a delivery device for delivering an initiator compound to the self-assembling thermoset polymeric mixture when in the reactor. In yet other embodiments, the drying device and the extruder are combined in a single extruding device, such as, but not limited to, a devolatilization extruder.

Yet another aspect of the invention features a continuous process for producing a hierarchical porous carbon material including the steps of (a) providing an organic thermoset polymer composition, wherein the organic thermoset polymer composition is capable of self-assembling when reacted in the presence of an initiator compound at a first temperature in the range from about 40° C. to about 130° C. and for a first period of time; (b) mixing the organic thermoset polymer composition to produce a phase-homogeneous polymer mixture; (c) reacting the phase-homogeneous polymer mixture at the first temperature and for the first period of time to produce a polymeric gel; (d) drying the polymeric gel at a second temperature in the range from about 40° C. to about 140° C. for a second period of time to produce a dried polymeric gel, wherein the second period of time is about 1 minute to about 12 hours; (e) extruding the dried polymeric gel to produce an extruded polymeric gel; and (f) pyrolyzing the extruded polymeric gel at a third temperature in the range from about 500° C. to about 1,200° C. for a third period of time to produce a porous carbon material, wherein the third period of time is about 10 minutes to about 12 hours. It is preferable that steps (b) through (e) be performed as an automatic, continuous process; more preferably, steps (b) through (f) are performed as an automatic, continuous process. For example, in some embodiments, this method utilizes the above-described system for manufacturing hierarchical porous carbon material. In a particular embodiment, the first temperature is about 60° C. to about 100° C. with a first period of time from about 1 minute to about 10 minutes, the second temperature is from about 75° C. to about 140° C. with a second period of time from about 1 minute to about 10 minutes, and/or the third temperature is from about 600° C. to about 1,000° C. In a particular embodiment, the first temperature is from about 75° C. to about 85° C., and the second temperature is from about 100° C. to about 130° C.

In some embodiments, the reacting step (c) further comprises a reactor selected from the group consisting of a plug-flow reactor, a tube-in-tube heat exchanger, and a tube-in-shell heat exchanger. In other embodiments, the plug-flow reactor is configured to inject the initiator compound into the phase-homogeneous polymer mixture during the reacting step to initiate self-assembly of the phase-homogeneous polymer mixture. In yet other embodiments, the extruding step (e) further comprises an extruder for extruding the dried polymeric gel to produce the extruded polymeric gel. For instance, the extruder can be selected from the group consisting of a screw extruder, a food extruder, a sieve extruder, a basket extruder, a roll extruder, a ram extruder, a pressure extruder, a hydraulic extruder, and a devolatilizing extruder. In a particular embodiment, the extruder is a devolatilizing extruder further configured to perform steps (d) and (e), i.e., to dry the polymeric gel and to extrude the dried polymeric gel. In still other embodiments, the pyrolysis step (f) comprises pyrolysis under an inert atmosphere, wherein the inert atmosphere comprises nitrogen and is substantially devoid of oxygen.

In some embodiments, the continuous process described herein produces a porous carbon material with a plurality of macropores defined by a wall, wherein the macropores have a diameter of from about 0.05 μm to about 100 μm, wherein the walls of the macropores comprise a plurality of mesopores defined by a wall, wherein the mesopores have a diameter of from about 2 nm to about 50 nm, and wherein the walls of the macropores and mesopores comprise a continuous carbon phase.

Other features and advantages of the invention will be apparent by reference to the drawings, detailed description, and examples that follow.

### BRIEF DESCRIPTION OF THE DRAWINGS

FIG. 1 depicts a flowchart of an embodiment of the manufacturing method described herein.

FIG. 2 depicts a diagram of an embodiment of the manufacturing method described herein.

FIG. 3A is a photograph of an embodiment of the polymeric gel following stamp-molding with a honeycomb mold.

FIG. 3B is a photograph of pyrolyzed carbon material produced in the stamp-molding, batch production method described in Example 1.

FIG. 4 are photographs of extruded polymer prior to pyrolysis in the batch production method described in Example 2. The left panel shows the extruded polymer. The right panel is provided for size reference.

FIG. 5A is a scanning electron microscope (SEM) image of an exemplary hierarchical porous carbon produced using the batch production method with lysine as the primary amine described in Example 3. Magnification is ×2,000. The white line is equal to 10 μm.

FIG. 5B is a scanning electron microscope (SEM) image from a different region of an exemplary hierarchical porous carbon produced using the batch production method with lysine as the primary amine described in Example 3. Magnification is ×2,000. The white line is equal to 10 μm.

FIG. 6A is a scanning electron microscope (SEM) image of an exemplary hierarchical porous carbon produced using the batch production method with activated carbon as a binder for extrusion described in Example 4. Magnification is ×1,300. The white line is equal to 10 μm.

FIG. 6B is a scanning electron microscope (SEM) image of an exemplary hierarchical porous carbon produced using the batch production method with activated carbon as binder for extrusion described in Example 4. Magnification is ×550. The white line is equal to 10 μm.

FIG. 7A is a scanning electron microscope (SEM) image of an exemplary hierarchical porous carbon produced using the semi-continuous production method described in Example 5. Magnification is ×2,700. The white line is equal to 10 μm.

FIG. 7B is a scanning electron microscope (SEM) image of an exemplary hierarchical porous carbon produced using the semi-continuous production method described in Example 5. Magnification is ×1,500. The white line is equal to 10 μm.

FIG. 8 is a photograph of exemplary extruded polymer produced in a continuous production method prior to transfer to a pyrolysis furnace by a conveyor belt.

FIG. 9A is a scanning electron microscope (SEM) image of an exemplary hierarchical porous carbon produced using the batch production and stamp-molding method described in Example 1. Magnification is ×1,900. The white line is equal to 10 μm.

FIG. 9B is a scanning electron microscope (SEM) image of an exemplary hierarchical porous carbon produced using the batch production and extrusion method described in Example 2. Magnification is ×850. The white line is equal to 10 μm.

FIG. 9C is a scanning electron microscope (SEM) image of an exemplary hierarchical porous carbon produced using the continuous production method described in Example 6. Magnification is ×1,500. The white line is equal to 10 μm.

### DETAILED DESCRIPTION OF THE INVENTION

Described herein are methods to produce hierarchically porous carbon materials in the desired form from a mixture of organic (carbon-containing) compounds. In general, the continuous process of the instant disclosure will include a reaction step, a drying step, a sizing and forming step (e.g., an extrusion step), and a pyrolysis step. In preferred embodiments, the process is automated such that once the feedstock composition is combined to produce a phase-homogeneous mixture, it is then reacted, dried, sized and formed, and pyrolyzed in a continuous process to produce suitable hierarchically porous carbon monoliths. The process provided herein produces hierarchically porous carbon monoliths with the desirable portion of mesopores to macropores in a safe and efficient manner including forming the material into the desired shapes or dimensions.

For purposes of this document and for clarity, All percentages referred to herein are percentages by weight (wt. %) unless otherwise noted.

Ranges, if used, are used as shorthand to avoid having to list and describe each and every value within the range. Any value within the range can be selected, where appropriate, as the upper value, lower value, or the terminus of the range.

The term “about” refers to the variation in the numerical value of a measurement, e.g., temperature, weight, percentage, length, concentration, and the like, due to typical error rates of the device used to obtain that measure. In one embodiment, the term “about” means within 5% of the reported numerical value.

As used herein, the singular form of a word includes the plural, and vice versa, unless the context clearly dictates otherwise. Thus, the references “a”, “an”, and “the” are generally inclusive of the plurals of the respective terms. Likewise, the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The term “comprising” is intended to include embodiments encompassed by the terms “consisting essentially of” and “consisting of”. Similarly, the term “consisting essentially of” is intended to include embodiments encompassed by the term “consisting of”.

The term “absorption” as used herein refers to the incorporation of a substance in one state into another substance of a different state, such as a liquid being absorbed by a solid or a gas being absorbed by a liquid.

The term “adsorption” as used herein refers to the physical adherence or the bonding of ions and molecules onto the surface of another phase.

The term “bi-continuous” as used herein refers to a material or structure containing two separate continuous phases such that each phase is continuous, and in which the two phases are interpenetrating, such that it is impossible to separate the two structures without tearing one of the structures.

The term “continuous” as used herein to refer to a phase means that all points within the phase are directly connected, so that for any two points within a “continuous” phase, there exists a path which connects the two points without leaving the phase.

The term “continuous” as used herein to refer to a manufacturing process or step means that the manufacturing process or step does not necessitate interruption for reasons other than by business decision. Generally, a continuous process can continue so long as requisite inputs (energy, raw materials, personnel, etc.) are available.

The term “highly branched” as used herein means that the polymer is a three dimensionally interconnected bi-continuous network of carbon polymer ligaments

The term “inert” as used herein refers to a substance that is not chemically reactive.

The term “monolith” as used herein refers to a macroscopic, single piece of material typically with one or more dimensional pores (i.e., length, width, and/or height) exceeding about 0.1 mm.

The term “particle” as used herein, generally refers to a discrete unit of material, such as a porous carbon material in particulate form, typically with the dimensions (length, width, and/or height) ranging from about 1 μm to about 1 mm. “Particles” may have any shape (e.g., spherical, ovoid, or cubic).

The term “nanoparticle” as used herein generally refers to a particle of any shape having an average particle size from about 1 nm up to, but not including, 1 μm. The size of “nanoparticles” can be experimentally determined using a variety of methods known in the art, including electron microscopy.

The term “phase” as used herein generally refers to a region of material or a structure that has a substantially uniform composition which is a distinct and physically separate portion of a heterogeneous system. The term “phase” does not imply that the material making up a phase is a chemically pure substance, be merely that physical properties of the material making up the phase are essentially uniform throughout the material, and that these properties differ significantly from the physical properties of another phase within the material or structure. Examples of physical properties include density, index of refraction, and chemical composition. A “phase” as used herein may refer to, e.g., a pore or network of pores, a void, or a wall formed from a solid layer of carbon.

The terms “phase homogeneous,” “homogeneous phase,” or “phase homogeneous end state” refer to a mixture of solids, liquids, or gases in which the substances are in a single phase. For instance, a “phase homogeneous” solution is a very stable mixture in which all solids have been dissolved in the solvent and the solute will not separate/precipitate out or be removed by filtration or centrifugation.

The term “pore-forming solid” refers to a solid material that serves as a seed for facilitating nucleation of a self-assembling polymer structure.

The term “polymeric” as used herein refers to a composition or material comprising one or more polymers, co-polymers, and/or block co-polymers.

The term “pyrolysis” refers to the chemical decomposition of organic materials through the application of heat. “Pyrolysis” is a burning process occurring in the absence or near absence of oxygen (or other oxidants) and is distinct from combustion. “Pyrolysis” often is carried out under an inert atmosphere, such as nitrogen gas, argon gas, or helium gas.

The term “self-assembly” refers to a process in which a disordered system of pre-existing components forms an organized structure or pattern as a consequence of specific, local (physical and/or chemical) interactions among the components themselves without the requirement of external direction.

The term “sorption” as used herein refers to a physical and chemical process by which one substance becomes attached to another substance. Absorption and adsorption are examples of “sorption.”

The term “thermoset” as used herein refers to polymer-based solutions that solidify under certain conditions called curing. This process creates a chemical cross-linking that forms an irreversible chemical bond.

The phrase “conventional means” refers to various equipment, equipment or physical arrangements, computer software, computer or physical applications, construction methods, and others that are well known in the art and readily available to accomplish a given set of parameters. Any single technology, arrangement, method, or others that accomplish a specific goal referred to in this document is interchangeable with another so long as the objectives or parameters required by the process described herein can be met (e.g., using either a 100 gallons-per-minute pump with design discharge pressure 90 pounds per square inch and a 120 gallons-per-minute pump with design discharge pressure of 100 pounds per square inch will suffice so long as both the (hypothetical) inlet conditions of 90 gallons-per-minute and 80 pounds per square inch of pressure are met).

Various publications, including patents, published applications and scholarly articles, are cited throughout the specification. Each of these publications is incorporated by reference herein in its entirety.

### Porous Carbon Materials

As discussed above, the continuous manufacturing process described herein produces hierarchically porous carbon materials, such as cylindrical monoliths or pellets. As one having ordinary skill in the art will appreciate in light of the teachings herein, the carbon materials can be made into any number of shapes and sizes depending on their intended use, including being ground into particles. The potential uses of these porous carbon materials include, but are not limited to, absorption, separation, remediation, sequestration-selective capture and separation of carbon dioxide, filters for water or air, heterogeneous catalyst supports, and the like. For instance, in one embodiment, small particles (e.g., nanoparticles of catalytically active metal) can be dispersed within the pores on the carbon phase to create carbon materials suitable for use as heterogeneous catalysts.

It is preferred that the carbon materials be porous, i.e., containing a plurality of small pores or openings, which increase the surface area of the carbon material (or the carbon phase) enabling better sorption and capture of, e.g., carbon dioxide and other gases or impurities. Moreover, the expanded surface area of the hierarchically porous carbon materials is particularly useful as a support for metal oxide/metal nanoparticle as catalyst materials. As such, the carbon materials provided herein may have pores, holes, and/or channels that may or may not extend throughout the entire length of the carbon material, which is sometimes referred to as the continuous carbon phase. The pores can also interconnect, resulting in a network of pores or voids that span the material, permitting the flow of liquid or gas into and through the material, i.e., a continuous phase of pores or voids. The carbon materials can also be described as bi-continuous (i.e., the carbon structures have two or more continuous phases), meaning that both a voids/pore phase and a carbon phase are continuous throughout the structure. It is additionally preferred that the carbon materials also include amines or other nitrogen groups to provide a nitrogen-containing framework for improving the sorption of carbon dioxide or other substances.

The pores of the carbon materials may be classified as micropores, mesopores, or macropores, depending on the size of the pore opening. The carbon materials provided herein may contain pores of any one or more of these sizes. For instance, in some embodiments, the carbon materials may contain micropores, while in others, the carbon materials may contain mesopores, while in still others, the carbon materials may contain macropores. It is preferred, however, that the carbon materials contain a plurality of macropores and/or mesopores, wherein the walls of the macropores and/or mesopores comprise the continuous carbon phase. In some embodiments, the porous materials will also comprise a plurality of micropores. In a particular embodiment, the carbon support structures comprise hierarchical pores, meaning these structures will contain pores spanning two or more different length scales, e.g., contain both macropores and mesopores. For instance, in an embodiment of a hierarchical pore arrangement, the carbon materials will include a plurality of macropores, the walls of which will comprise a plurality of mesopores. Moreover, the walls of the macropores and/or mesopores may also comprise a plurality of micropores.

In some embodiments, the carbon structures comprise a plurality of macropores. Macropores are pores or voids having a diameter greater than about 0.05 μm. For example, the macropores can have a diameter greater than about 0.05 μm, greater than about 0.075 μm, greater than about 0.1 μm, greater than about 0.75 μm, greater than about 1.0 μm, greater than about 1.5 μm, greater than about 2.0 μm, greater than about 2.5 μm, greater than about 5 μm, greater than about 10 μm, greater than about 15 μm, or greater. In some embodiments, the macropores have a diameter of less than about 100 μm (e.g., less than about 100 μm, less than about 90 μm, less than about 80 μm, less than about 70 μm, less than about 60 μm, less than about 50 μm, less than about 40 μm, less than about 30 μm, less than about 25 μm, less than about 20 μm, less than about 15 μm, less than about 10 μm, less than about 7.5 μm, less than about 5 μm, less than about 2.5 μm, less than about 2.0 μm, less than about 1.5 μm, less than about 1.0 μm, less than about 0.75 μm, less than about 0.5 μm, less than about 0.25 μm, or less).

The macropores can have a diameter ranging from any of the minimum values to any of the maximum values described above. In some embodiments, the macropores have a diameter of from about 0.05 μm to about 100 μm. In certain instances, the macropores have a diameter of from about 0.5 μm to about 30 μm, from about 1 μm to about 20 μm, from about 5 μm to about 15 μm, from about 10 μm to about 30 μm, or from about 0.5 μm to about 15 μm in diameter. The macropores can have a substantially constant diameter along their length.

In some embodiments, the diameter of the macropores is substantially constant from macropore to macropore throughout the material, such that substantially all (e.g., at least 75%, at least 80%, at least 85%, at least 90%, or at least 95%) of the macropores in the material have a diameter that is within 40% of the average macropore's diameter (e.g., within 35% of the average macropore's diameter, within 30% of the average macropore's diameter, within 25% of the average macropore's diameter, within 20% of the average macropore's diameter, within 15% of the average macropore's diameter, or within 10% of the average macropore's diameter).

The walls of the macropores are formed from a continuous carbon phase. In some embodiments, the walls have a thickness of from about 50 nm to about 15 μm, for example, from about 50 nm to about 600 nm, from about 100 nm to about 500 nm, from about 200 to about 400 nm, from about 50 nm to about 200 nm, from about 300 nm to about 600 nm, from about 500 nm to about 5 μm, from about 5 μm to about 10 μm, or from about 5 μm to about 15 μm.

In preferred embodiments, the carbon structures comprise a plurality of mesopores. In some embodiments, the carbon structures will comprise a plurality of macropores and the walls of the macropores will comprise a plurality of mesopores, thereby forming a hierarchically porous material.

Mesopores are pores, holes, voids, and/or channels having a diameter ranging from about 2 nm to about 50 nm. For example, the mesopores can have a diameter greater than about 2 nm, greater than about 3 nm, greater than about 4 nm, greater than about 5 nm, greater than about 7.5 nm, greater than about 10 nm, greater than about 15 nm, greater than about 20 nm, greater than about 25 nm, greater than about 30 nm, or greater. In some embodiments, the mesopores have a diameter of less than about 50 nm (e.g., less than about 40 nm, less than about 35 nm, less than about 30 nm, less than about 25 nm, less than about 20 nm, less than about 15 nm, less than about 10 nm, less than about 7.5 nm, less than about 6 nm, less than about 5 nm, or less). For example, the mesopores can have a diameter ranging from about 2 nm to about 30 nm, from about 10 nm to about 20 nm, from about 15 nm to about 50 nm, from about 2 nm to about 6 nm, or from about 2 nm to about 15 nm in diameter.

The mesopores can have a substantially constant diameter along their length. In some embodiments, the diameter of the mesopores is substantially constant from mesopore to mesopore throughout the material, such that substantially all (e.g., at least 75%, at least 80%, at least 85%, at least 90%, or at least 95%) of the mesopores in the material have a diameter that is within 40% of the average mesopore's diameter (e.g., within 35% of the average mesopore's diameter, within 30% of the average mesopore's diameter, within 25% of the aver-age mesopore's diameter, within 20% of the average mesopore's diameter, within 15% of the average mesopore's diameter, or within 10% of the average mesopore's diameter).

The walls of the mesopores are formed from a continuous carbon phase. In some embodiments, the walls have a thickness of from about 5 nm to about 15 μm, for example, from about 5 nm to about 10 μm, from about 5 nm to about 5 μm, from about 5 nm to about 1 μm, from about 5 nm to about 800 nm, from about 5 nm to about 600 nm, from about 5 nm to about 500 nm, from about 5 nm to about 400 nm, from about 5 nm to about 200 nm, from about 5 nm to about 10 nm, from about 5 nm to about 50 nm, or from about 5 nm to about 25 nm. In some instances, the walls have a thickness of greater than 5 nm (e.g., greater than 10 nm, greater than 15 nm, greater than 20 nm, or greater).

In some embodiments, the carbon structures comprise a plurality of micropores. In some embodiments, the walls of the macropores, mesopores, or combinations thereof further contain micropores. Micropores are pores, holes, and/or channels that have a diameter of less than about 2 nm. For example, micropores can have a diameter ranging from about 0.2 nm to 2 nm. The walls of the micropores can be formed from a continuous carbon phase.

In a preferred embodiment, the process described herein is a continuous process for the manufacture of hierarchically porous carbon structures. In some embodiments, the structures can be described as hierarchically porous carbon monoliths. Further, the hierarchically porous carbon structures described herein can be characterized as possessing two or more continuous phases (e.g., a void phase and a carbon phase). The two or more phases are generally tortuous, such that the two or more phases are interpenetrating. Moreover, imparting mesopores to the carbon structures enhances sorption kinetics (e.g., carbon dioxide sorption kinetics).

In some aspects of the present invention, the pores or openings of the porous carbons structures are formed as a result of the self-assembly and polymerization of organic chemical compounds. For instance, during the polymerization reaction, these chemical compounds in the form of monomers will react with other monomer chemical compounds to form a gel-like suspension consisting of bonded, cross-linked macromolecules with deposits of liquid solution (i.e., sol-gel polymerization) or gas (i.e., aerogel polymerization) between them. In a sol-gel polymerization process, the heat curing and drying steps cause the evaporation of the liquid solution deposits thus leaving behind the cross-linked molecular frame. The resulting heat-cured and dried gel is subjected to pyrolysis. In some embodiments, the cured and dried gel is extruded into carbon structures, such as cylinders or monolith structures, having a diameter of about 1 mm to about 6 mm (e.g. and a length from about 0.1 mm to about 10 mm. Preferably, the average length of a carbon monolith is from about 1 mm to about 6 mm (e.g., 1 mm, 2 mm, 3 mm, 4 mm, 5 mm, or 6 mm). For instance, in one particular embodiment, the average length of a carbon monolith produced herein is about 4 mm. In other embodiments, the extruded material is pulverized or ground into smaller particles and subjected to pyrolysis to produce a carbon powder with particle sizes less than about 1 mm (e.g., 0.9 mm, 0.8, mm, 0.7 mm, 0.6 mm, 0.5 mm, 0.4 mm, 0.3 mm, 0.2 mm, 0.1 mm, or smaller). In yet other embodiments, the extruded material is pyrolyzed and the resulting carbon extrudates are ground into smaller particles to produce a carbon powder with particles sizes less than about 1 mm (e.g., 0.9 mm, 0.8, mm, 0.7 mm, 0.6 mm, 0.5 mm, 0.4 mm, 0.3 mm, 0.2 mm, 0.1 mm, or smaller). Suitable grinding equipment include, but not limited to, ball-mills, rock tumblers, or food grinders.

As noted above, the pores are formed by a self-assembling polymerization process. As such, the carbon-containing components of the polymerization reaction should be chosen based on their ability to react to form the macromolecular structures with hierarchically porous characteristics. Suitable chemical mixtures for producing the hierarchically porous carbon structures will now be described in more detail.

### Polymer Compositions

Provided herein are chemical mixtures that comprise organic compounds (i.e., compounds containing carbon-hydrogen bonds) that are capable of self-assembly via polymerization to form the macromolecular carbon material that will be further cured, dried, extruded, and pyrolyzed to produce the hierarchically porous carbon monoliths. As one having ordinary skill in the art would recognize, self-assembly is a process whereby a mixture of components (e.g., chemical compounds) forms an organized structure as a consequence of specific interactions among the components themselves. Typically, these compositions will comprise thermoset mixtures of polymers that crosslink together during the self-assembly process. In some embodiments, the thermosets are highly branched. In further aspects, hierarchically porous carbon monoliths are provided that comprise a nitrogen-containing framework for conferring to the carbon structure improved gas (e.g., carbon dioxide) sorption. For instance, amine groups may be introduced into the porous carbon material during the polymerization step. In some embodiments, a sol-gel is provided that is produced by curing (e.g., heat-curing) a self-assembled block co-polymer-phenolic resin gel with the majority of the curing done at the reaction step, which is carried out under heat. In turn, the polymeric sol-gel is processed (dried and pyrolyzed) to produce the hierarchically porous carbon monolith product. The instant disclosure refers to polymeric gels, which may include either sol-gels or aerogels containing polymers.

The self-assembling carbon-containing mixtures will comprise a mixture of chemical compounds capable of undergoing polymerization to form the macromolecular carbon structures. For instance, suitable compositions for self-assembly of a hierarchically porous carbon material may include a mixture of an alcohol (—OH), organic amine (—NH₂), and an aldehyde (—CHO) (e.g., formaldehyde), and a carbonyl or aromatic compound. A mixture of these classes of carbon-containing compounds will undergo what is known in the art as a Mannich reaction, which is a reaction commonly used in the art for the construction of nitrogen-containing compounds. In a Mannich reaction, an aldehyde and an organic amine can facilitate the amino alkylation of an acidic proton on a carbonyl functional group or aromatic ring to produce a Mannich base. The resulting Mannich base compound can then be polymerized to form the polymeric solution. It is preferable that these self-assembling mixtures will include an organic amine, an aldehyde, and a carbonyl or aromatic compound. In some embodiments, the self-assembling mixture will additionally contain one or more solvents, such as ethanol, methanol, propanol, glycols, a surfactant, and/or deionized (DI) water.

The component that contains the hydroxyl (‘—OH’) group or aromatic ring can be selected from a variety of suitable compounds, including urea, an imide (e.g., succinimide, maleimide, glutarimide, phthalimide, and melamine) or a phenol (e.g., benzenediols, such as hydroquinone, and benzenetriols). For instance, these components can be used to produce polyurea gels (e.g., DESMODUR RE polyisocyanate mixed with water and triethylamine), polyimide gels, and/or block co-polymer-phenolic gels. In a preferred embodiment, a block co-polymer-phenolic gel is produced in a Mannich reaction that includes, inter alia, a phenolic compound. Phenolic compounds suitable for use in the mixture include benzenediols (such as resorcinol, catechol, or hydroquinone) or benzenetriols. In a particular embodiment, the phenolic compound is a benzenediol, which may be selected from one or more of three benzenediol isomers that include 1,2-benzenediol (ortho-benzenediol or Catechol), 1,3-benezenediol (meta-benzenediol or Resorcinol), or 1,4-benezenediol (para-benzenediol or Hydroquinone). In a particular embodiment, the composition includes the benzenediol, Resorcinol. The amount of the carbonyl/aromatic compound present in the reaction ranges from about 5% wt to about 40% wt, e.g., 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% wt. Preferably, it is present in the amount of about 5% to about 20% wt. For instance, in one particular embodiment, about 11% to about 12% by weight Resorcinol was included in the reaction. In another other embodiments, about 6% to about 14% Resorcinol was included in the reaction.

The Mannich reaction also requires an aldehyde and an organic amine component. Thus, provided herein are reaction mixtures that include one or more organic amines for activating an aldehyde. Preferably, the organic amine is a protic amine, e.g., a primary or secondary amine. Suitable organic amines for use in a Mannich reaction for production of the self-assembled polymeric gel in the process provided herein include, but are not limited to, amino acids (e.g., L-lysine), melamine, pyrrolidine, polyvinyl pyrrolidine (PVP), 1,6-diaminohexane (DAH), ethylenediamine (EDA), and dimethylamine (DMA). For instance, in one particular embodiment, DAH or lysine was chosen as the primary amine. The amount of the amine present in the Mannich reaction ranges from about 0.01% wt to about 40% wt, e.g., 0.01%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 15%, 20%, 25%, 30%, 35%, or 40% wt. Preferably, it is present in the amount of about 0.1% to about 5% wt. For instance, in one particular embodiment, about 0.3 to 0.4% by weight DAH is present in the reaction. In another embodiment, about 0.6% to about 0.7% by weight lysine is present in the reaction.

The reaction composition will also include an aldehyde. Suitable aldehydes include, formaldehyde (e.g., formalin), benzaldehyde, branched and straight butyraldehyde, or an aldehyde-forming compound such as trioxane. The aldehyde can be added to initiate the self-assembly reaction—either all at once or in-line as the reaction proceeds. The amount of the aldehyde present in the reaction ranges from about 1% wt to about 30% wt, e.g., 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% wt. Preferably, it is present in the amount of about 10% to about 20% wt. For instance, in one particular embodiment, about 16% to about 17% by weight formaldehyde is present in the reaction.

While not wishing to be bound by theory, the proportion of mesopores in the hierarchically porous carbon structure may be influenced by the molar quantity of amine in relation to the carbonyl or aromatic compound. As the molar ratio of amine to carbonyl/aromatic compound increases, the reaction rate increases and, at some point, the reaction time becomes too rapid resulting in the loss of mesopore structure. Therefore, it may be desirable in some embodiments to include in the reaction mixture a ratio of carbonyl or aromatic compounds to amines that favors the production of mesopores. Thus, in particular embodiments, the molar ratio of carbonyl/aromatic compound to amine in the reaction mixture or feedstock will be from about 1:1 to about 150:1. In some embodiments, a greater proportion of mesopores to micropores are preferred and, as such, the molar ratio of carbonyl/aromatic compound to amine in the reaction mixture or feedstock will be from about 5:1 to about 100:1, e.g., about 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1, 31:1, 32:1, 33:1, 34:1, 35:1, 36:1, 37:1, 38:1, 39:1, 40:1, 41:1, 42:1, 43:1, 44:1, 45:1, 46:1, 47:1, 48:1, 49:1, 50:1, 60:1, 70:1, 80:1, 90:1, or 100:1. In a more preferred embodiment, the molar ratio of carbonyl/aromatic compound to amine in the reaction mixture or feedstock will be from about 20:1 to about 50:1. For instance, in one non-limiting embodiment, the molar ratio of carbonyl/aromatic compound to amine in the reaction mixture or feedstock is about 40:1 (e.g., Resorcinol to DAH).

In some embodiments, the reaction composition further comprises one or more surfactants to serve as soft-templates to facilitate self-assembly of the carbon-containing polymers. Suitable surfactants may include ionic or non-ionic surfactants, including, but not limited to poloxamers (e.g., PLURONIC L64, PLURONIC P123, PLURONIC F127, and PLURONIC F108) that can be used as non-ionic surfactants and cetyl trimethyl ammonium bromides (CTABs), steartrimonium bromides (STABs), tetradecyltrimethylammonium bromides (TTABs), cetyltrimethylammonium chlorides (CTACs), and lauryltrimethylammonium bromides (LTABs). Poloxamers are hydrophilic, nonionic copolymer surfactants composed of a central hydrophobic chain of poly(propylene oxide) flanked by poly(ethylene oxide) chains. Poloxamers used in the reaction composition may have a molecular mass from about 1,000 g/mol to about 20,000 g/mol and a poly(ethylene oxide) content in the range from about 10% to about 80%. For instance, in one exemplary composition, poloxamer 407 is used (about 12,500 g/mol and about 70% poly(ethylene oxide) content). Ionic surfactants suitable for use herein include CTABs with varying chain lengths like, such as C₁₈TAB and C₁₄TAB. While not wishing to be bound by theory, it is believed that the interaction between the surfactant and the amine component help induce the self-assembly of the mesostructures in the carbon monolith. Therefore, it may be desirable in some embodiments to include in the reaction mixture a ratio of amine to surfactant that favors the production of mesopores. In some embodiments, the molar ratio of amine to surfactant in the reaction mixture or feedstock will be from about 1:1 to about 200:1, e.g., about 1:1, 2:1, 3:1, 4:1, 5:1, 6:1, 7:1, 8:1, 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 110:1, 120:1, 130:1, 140:1, 150:1, 160:1, 170:1, 180:1, 190:1, or 200:1. In a more preferred embodiment, the molar ratio of amine to surfactant in the reaction mixture or feedstock will be from about 2:1 to about 75:1. For instance, in one non-limiting embodiment, the molar ratio of amine to surfactant in the reaction mixture or feedstock is about 6.8:1 (e.g., DAH to poloxamer 407).

In other embodiments, a pore-forming solid may be added to the mixture as an alternative or in addition to the surfactant component. As one having ordinary skill in the art will recognize, pore-forming solids can function as a seed for nucleation of the self-assembling polymer structure. Suitable pore-forming solids include, but are not limited to, silica beads, wax beads, and Styrofoam beads. It may also be desirable to add a binding agent for the shaping/extrusion step. In one particular embodiment, activated carbon is used as the binding agent.

As noted above, the various mixtures of chemical compounds described herein are mixed to form the organic polymeric solution. However, to produce the desired porous carbon materials suitable for carbon dioxide scrubbing or as a support for, e.g., metal particles, the polymeric solution that results from the self-assembly must still be cured to harden the structure, dried to remove the solvent deposits leaving behind macropores, mesopores, and/or micropores, formed to the desired shape, and pyrolyzed to form the final product. Moreover, in order to create a continuous process, the inventors have replaced the existing stamp-molding step with an extrusion step. However, this required modification of the drying step and the inclusion of the extrusion step after the drying step. Furthermore, the inventors have included a reactor, such as a plug-flow reactor or tube-in-tube heat exchanger that provides for efficient reaction conditions allowing for self-assembly and the initiation of curing of the polymeric gel material. The manufacturing process will now be described in greater detail.

### Manufacturing Process

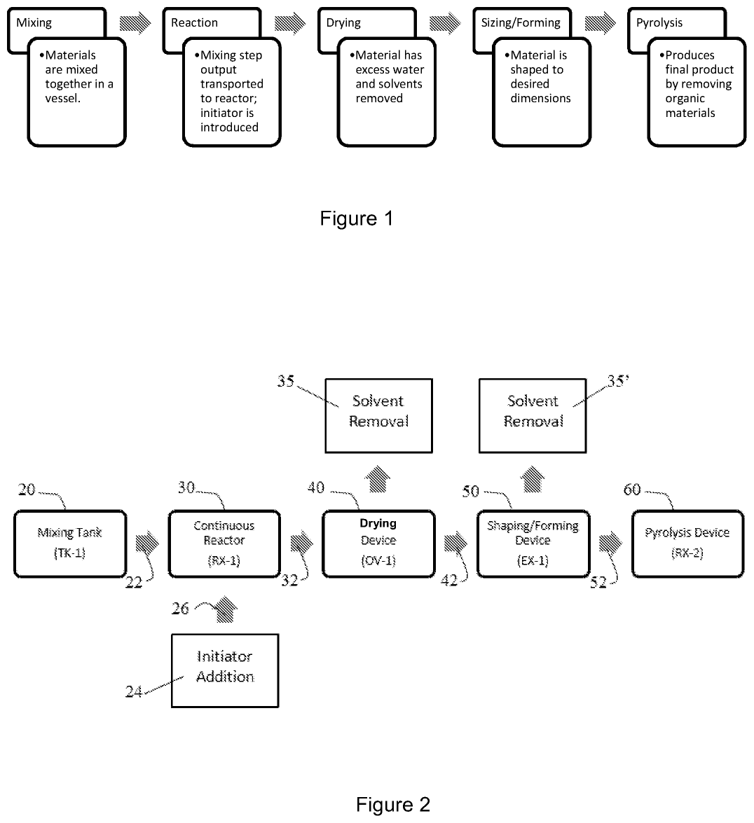

As noted above, it is an object of this disclosure to provide a process for manufacturing hierarchically porous carbon materials. The source of carbon for creating the carbon structures is provided by combining organic compounds capable of self-assembly. In general, the process described herein may include steps for mixing, reacting, drying, extruding, reducing the size of the product, pyrolysis and activating the product to produce hierarchically porous carbon materials from an organic feedstock. FIG. 1 depicts a graphical representation of the process overview.

In general, the mixing step includes the mixture of carbon-containing compounds in the appropriate ratios and the appropriate conditions in a vessel using art-standard and conventional means. Suitable polymer compositions are described in greater detail elsewhere herein. In a preferred embodiment, the polymeric compositions are thermoset mixtures or organic compounds capable of crosslinking during self-assembly. In some embodiments, the organic polymer compositions are highly branched, crosslinked, thermoset polymeric mixtures. In general, all components are added in the mixing step, with the exception of the initiator, which can be added after the initial mixing step and immediately prior to the beginning of the reacting step to initiate the self-assembly reaction. In some embodiments, a binding agent, such as activated carbon can be added to the mixture of compounds to improve the binding of the dried polymeric gel when extrusion is used for the shaping and sizing of the dried polymeric gel. In addition, a suitable solvent, a soft template, such as a surfactant, and/or a pore-forming solid may be added to the mixture. All materials (except the initiator) can be introduced in any order to the mixing vessel by any conventional means desired by the operator. The components may be mixed until they reach a phase-homogeneous state.

The resulting carbon-containing mixture from the mixing step is then transported to a reactor (e.g., a plug flow reactor or a tube-in-tube heat exchanger) by conventional means. Typically, an initiator (e.g., formalin) is injected into reaction at this step to facilitate the self-assembly of the carbon polymer mixture. The reaction is allowed to occur for a pre-determined period of time and at the appropriate temperature such that the reactants harden into a semi-dry material (e.g., a cured polymeric gel). As noted above, the self-assembling polymeric gel is heat-cured. The majority of the curing occurs during the reaction step. In some embodiments, at least about 60% to about 90%, e.g., 60%, 65%, 70%, 75%, 80%, 85%, or 90%, or more of the polymeric gel is cured in the reaction step. For the drying step, the polymeric gel is introduced into a vessel capable of removing excess liquids (e.g., solvents, water, etc.). Moreover, the drying step substantially completes the curing of the polymeric gel. This vessel will typically consist of a mechanism for solvent removal as a vapor, as a phase-separated liquid, or both. This vessel can be equipped with agitators, vacuum pumps, above-ambient pressure capabilities, various nozzle geometries, or all of the above to accomplish the goal of liquid removal. The removed material may be re-used in the process, thermally decomposed, or otherwise discarded as waste. The dried polymeric gel is then shaped and formed into a specific geometry prior to pyrolysis. The material can be shaped into any geometry desired using conventional means or standard techniques known in the art, such as, but not limited to extrusion, pour molding, injection molding, casting, and the like.

The final step typically utilizes pyrolysis to process the cured, dried, and shaped product. For pyrolysis, the material should be transported as soon as possible to equipment or device(s), such as, but not limited to, a kiln, oven, furnace, or chamber suitable and configured for heating the material in the absence of oxygen to a temperature of greater than about 500° C. for a period of time sufficient for carbonization of the material. This step, in particular, removes all remaining (unreacted) substances with the exception of carbon to result in a hierarchically porous carbon material. The removed material may be collected and re-used in this process, thermally decomposed, or otherwise discarded as waste.

Thus, provided herein is an innovative method for the continuous production of hierarchically porous carbon materials. Importantly, the methods provided herein allows for a continuous process from the beginning to the end of the polymeric self-assembly reaction; causes the removal of solvents and water from the material to a specified recovery (measured as the recovered water/solvent amount divided by the beginning water/solvent amount); facilitates the sizing and shaping of the polymeric material in order to retain the desired hierarchically porous structure; enables any desired further drying of the shaped and sized polymeric material; and provides for the pyrolysis of the polymeric material into a monolithic, hierarchically porous carbon material of characterized and uncharacterized pore structure, diameter, and distribution.

The manufacturing process provided herein is substantially preferable to previously practiced methods which utilized batch processing methods. Shown in FIG. 2 is a representation of the continuous production process that includes a mixing tank (TK-1) 20, continuous reactor (RX-1) 30, a drying device (OV-1) 40, a shaping/forming device (EX-1) 50, and a pyrolysis device (RX-2) 60. The process will now be described in further detail.

### Mixing

As noted above, the process begins with a mixing step where a feedstock containing the desired reaction components is mixed in a suitable mixing vessel for a predetermined time and at a predetermined temperature. In an embodiment, the feedstock is a thermoset polymeric mixture capable of self-assembly in the presence of an initiator and when subjected to an appropriate reaction temperature and residence time. In a particular embodiment, the feedstock is capable of self-assembling into a highly-branched, crosslinked, thermoset polymeric gel containing carbon. Suitable mixing vessels include any conventional vessel or means known in the art for mixing components, such as a mixing tank. In a preferred embodiment, all non-reacting components of the polymer composition are added to the mixing vessel, with the exception of the initiator, which is preferably held out until after the components are mixed to a phase-homogeneous end state at a desired temperature. In some embodiments, the vessel can first be agitated lightly to encourage mixing after the initial addition of the non-reacting components after which the mixing can be halted and restarted as needed without having an adverse effect on the polymer composition.

Shown in FIG. 2 is a mixing step that includes a mixing tank (TK-1) 20 wherein a suitable feedstock of non-reacting components is mixed for a predetermined time in the range from about 1 minute to about 5 hours, or more, e.g., about 1 minute, 5 minutes, 10 minutes, 15 minutes, 20 minutes, 25 minutes, 30 minutes, 35 minutes, 40 minutes, 45 minutes, 50 minutes, 55 minutes, 1 hour, 1.5 hours, 2 hours, 2.5 hours, 3 hours, 3.5 hours, 4 hours, 4.5 hours, 5 hours, or more. Suitable mixing temperatures range from about 10° C. to about 50° C., e.g., about 10° C., 15° C., 20° C., 25° C., 30° C., 35° C., 40° C., 45° C., or 50° C.

As discussed herein, the feedstock composition will be capable of self-assembly via polymerization. Suitable self-assembly polymer compositions include, but are not limited to, a mixture of an alcohol, an organic amine, an aldehyde, and a carbonyl or aromatic compound. In some embodiments, the compositions further include a surfactant, solvent, pore-forming solid, and/or a binding agent. In a preferred embodiment, the aldehyde is held out of the mixture until just prior to the reacting step. As summarized in FIG. 2, once the feedstock mixture has reached a phase homogeneous end state (e.g., fully dissolved in solution) at a desired temperature, e.g., about 10° C. to about 50° C., the material is then transported to the continuous reactor (RX-1) 30 via transporter member 22, which can be a conventional or art-standard transporter such as, but not limited to, belt conveyer, pneumatic conveyor, pipe, tube, or pump (e.g., vacuum pump or peristaltic pump). Once the phase-homogeneous feedstock mixture is in the continuous reactor (RX-1) 30, the reaction can be initiated.

### Reacting

The reacting step includes initiating the self-assembly reaction of the polymer solution with the addition of an initiator compound. As one having ordinary skill in the art would appreciate, the identity of the initiator compound typically depends on the particular composition being self-assembled. For instance, in one embodiment, the initiator compound is an aldehyde, such as formalin or formaldehyde. The reaction of the phase-homogeneous mixture with the initiator is typically carried out in a reactor. For the reaction to take place, time at the appropriate temperature is required in order to harden the reactants into a semi-dry material (or gel). Moreover, as noted above, the majority of the curing is completed during the reaction step. In a preferred embodiment, the reactor is a plug-flow type reactor or a tube-in-tube heat exchanger of sufficient length. Other suitable reactors may include a tube-in-shell heat exchanger.

These types of reactors can be built from conventional piping or tubing (e.g., steel, rubber, or plastic) or can be adapted from commercially available piping or tube-in-tube heat exchangers. In one embodiment, a reactor may be used and held at one or more temperatures (e.g., zones) to allow for the reaction to take place and product gel to form. For instance, the reactor can be adapted to apply one or more temperature zones along its length such that as the self-assembling reactant mixture is flowed through the piping, it is exposed to different temperatures. In one embodiment, the reactor has one temperature zone in the range from about 40° C. to about 130° C., e.g., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., or 130° C. In some embodiments, the reaction temperature is from about 60° C. to about 100° C., or from about 75° C. to about 85° C. For instance, in one embodiment, the self-assembling mixture includes a phenolic compound, surfactant, alcohol, amine, and aldehyde and the reaction temperature is from about 60° C. to about 120° C. In a particular embodiment, the reaction temperature is about 120° C. In another particular embodiment, the reaction temperature is 80° C. to 82° C. In another embodiment, the reactor has two or more temperature zones, each of which is in the range from about 40° C. to about 130° C., e.g., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., or 130° C. In such embodiments, the temperature zones can each be at different temperatures. The length of the reactor piping/tubing may vary depending on the scale of the production and the number of temperature zones desired. The length of the reactor is typically at least about 1 ft to about 100 ft, e.g., 1 ft, 5 ft, 10 ft, 15 ft, 20 ft, 25 ft, 30 ft, 35 ft, 40 ft, 45 ft, 50 ft, 55 ft, 60 ft, 65 ft, 70 ft, 75 ft, 80 ft, 85 ft, 90 ft, 95 ft, or 100 ft. While the optimal length of the reactor will vary with temperature, in a particular embodiment, a reactor with a temperature zone at about 75° C. to about 85° C. or about 100° C. to about 120° C. is preferably about 50 ft. There may be multiple heating (or cooling) zones depending on the specific conditions necessary for each discreet formulation to react, self-assemble, cure, dry or extrude in the reactor. One or all of these unit operations may be performed in the primary reactor or in sequentially connected equipment designed for the purpose of performing these steps.

Sufficient residence time of the mixture in the reactor is required to ensure that the self-assembling reaction mixture has polymerized to a semi-hardened, gel-like material. As noted above, about 60% to about 90%, or more; preferably, about 80% to about 90% of the polymeric gel is cured in the reaction step. The selection of residence time will depend on various factors, such as temperature, pressure, polymeric composition, and the like and it is well within the purview of the skilled artisan to optimize the residence time parameters. Typical residence time is in the range from about 1 minute to about 120 minutes, e.g., 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, or 120 minutes. In a preferred embodiment, the residence time is in the range from about 1 minute to about 60 minutes. In a more preferred embodiment, the residence time is in the range from about 1 minute to about 10 minutes or about 5 minutes to about 10 minutes.

In some embodiments, the reactor is held at a specific pressure, which can be measured at any given point along the reactor and held constant by way of manipulating equipment or process parameters in order to keep all reactants in the liquid state. The pressure of the system may be in the range from about 0 psi to 100 psi, preferably, from about 0 psi to about 15 psi. In other embodiments, static mixers or agitation is used to prevent the solution from phase separating.

As shown in FIG. 2, the phase-homogeneous mixture is transported from the mixing tank (TK-1) 20 to the continuous reactor (RX-1) 30 by way of the transporter member 22. In the particular embodiment depicted in FIG. 2, the continuous reactor (RX-1) 30 is a plug-flow reactor. As the phase-homogeneous mixture is fed into the continuous reactor (RX-1) 30, the initiator (e.g., formalin or trioxane) 24 is added to the mixture (e.g., in-line injector 26) to initiate the self-assembly reaction. In this particular embodiment, the reaction components (with initiator) travel through RX-1 30 while being heated to operating temperature in range of about 40° C. to about 130° C. In some embodiments, the operating temperature is in the range of about 60° C. to about 100° C.

### Drying

Upon exit from the reactor, the self-assembled polymeric gel material proceeds to the drying step by conventional means of transport, such as, but not limited to, belt conveyer, pneumatic conveyor, pipe, tube, or pump (e.g., vacuum pump or peristaltic pump). For the drying step, the polymeric gel is then introduced into a vessel or vessels capable of removing excess liquids (e.g., solvents, water, etc.). This vessel(s) will typically consist of a mechanism for solvent removal as a vapor, as a phase-separated liquid, or both. This vessel(s) can be equipped with agitators, vacuum pumps, above-ambient pressure capabilities, various nozzle geometries, or all of the above to accomplish the goal of liquid removal. The removed material may be re-used in the process, thermally decomposed, or otherwise discarded as waste.

During the drying step, the unreacted compound(s) (e.g., the aldehydic compound) and the solvent phase begin to be evaporated off resulting in the formation of dried porous polymeric gel phase. In some embodiments, the polymeric gel is dried at a temperature in the range from about 40° C. to about 150° C., e.g., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., or 150° C. for a time period of about 1 minute to about 15 hours or more, e.g., about 1 minute, 10 minutes, 20 minutes, 30 minutes, 40 minutes, 50 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, or more. In one embodiment, the drying temperature is from about 75° C. to about 140° C.; in another embodiment, the temperature is about 100° C. to about 130° C. Furthermore, the drying time can be as short as about 1 minute to about 10 minutes, or about 5 minutes to about 10 minutes. In a particular embodiment, the cured polymeric gel is dried at a temperature in the range from about 45° C. to about 60° C. for about 5 hours to about 12 hours. In another embodiment, the cured polymeric gen is dried at a temperature of about 120° C. for about 5 minutes to 10 minutes. In another particular embodiment, the cured polymeric gel is dried at a temperature in the range from about 75° C. to about 85° C. for a period of about 5 minutes to about 30 minutes. As noted above, in a preferred embodiment, the curing of the polymeric gel is substantially completed in the drying step.

The drying may be performed in art standard drying equipment/vessels. In a particular embodiment, a devolatilizing extruder is used in combination of varying temperatures and pressures to achieve liquid removal. Liquid is removed as a vapor by lowering pressure and/or elevating temperature in specific zones of the extruder that are specially designed for this operation.

FIG. 2 depicts the drying of the output material that is transported from the reactor RX-1 30 to the drying device OV-1 40 via transporter member 32, which can be a conventional transporter (e.g., belt conveyer, pneumatic conveyor, pipe, tube, or pump). Once in the OV-1 40, the unreacted aldehydic compound and the solvent phase begin to be evaporated off (i.e., solvent removal 35) resulting in the formation of dried porous polymeric gel phase. The drying step may be performed in the OV-1 40, at a temperature in the range from about 40° C. to about 140° C. for a time period of about 1 minute to about 10 hours or more. In particular embodiment, the drying is performed in the OV-1 40 at a temperature in the range from about 75° C. to about 85° C. for a period of time of about 5 minutes to about 30 minutes. In another particular embodiment, the drying is performed in the OV-1 40 at a temperature of about 120° C. for about 5 to 10 minutes.

In other embodiments, additional drying may be performed before or after the extruder (i.e., the sizing/forming step) to further remove volatiles (e.g., solvent removal 35′) or harden the material. In one embodiment, this may be performed with a continuous oven, tunnel or other system designed for time and temperatures appropriate for processing of the extrudates.

### Sizing/Forming

In this step, the cured and dried polymeric gel is shaped and formed into a specific geometry prior to pyrolysis. The material can be shaped into any geometry and size desired using art-standard techniques, such as extrusion, pour molding, injection molding, casting, extrusion-spheronization, pelletization, and the like. This step may be performed under various temperatures or pressures or a range of both.

In one embodiment, an extruder is utilized to form the material. An extruder applies hydraulic force to a material along a longitudinal axis by forcing the material against a die face at the end of a chamber. The die of the extruder is fashioned to provide backpressure on the auger(s) of the extruder and also to force the material into the desired dimension and/or geometries. For instance, in a particular embodiment, the hierarchically porous carbon material is in the shape of a cylinder. The material exiting the extruder is then cut at a specific time to achieve the specific shapes desired. Exemplary extruders include, but are not limited to, screw extruders (e.g., single or twin extruders, axial/radial-type extruders), continuous Sev extruders, food extruders, sieve extruders, basket extruders, roll extruders (e.g., one/two/rotating perforated roll extruders), ram extruders, pressure extruders, hydraulic extruders, or devolatilizing extruders. For instance, in a particular aspect, the extruder is a devolatilizing extruder configured to cure the polymeric gel and dry the cured polymeric gel, and the like. The die of the extruder may be selected from any size and shape to give the extruded gel the desired shape and diameter. In an embodiment, the die aperture is a rectangle, square, triangle, hexagon, star, hollow tube, or circle. Moreover, the diameter of the die aperture can be from about 1 m to about 10 mm, e.g., 1 mm, 2 mm, 3 mm, 4 mm, 5 mm, 6 mm, 7 mm, 8 mm, 9 mm, 10 mm.

In another embodiment, the polymeric gel is shaped and formed into a spherical or bead shape by extrusion followed by spheronization. For instance, the sizing/forming step may include an extruder and a pelletizer that is attached to a spheronizer (such as a Marumizer spheronizer) for spheronizing the extruded polymer.

In FIG. 2, the dried polymeric gel is fed into the sizing and forming equipment EX-1 50 by transporter member 42, which can be a conventional means of transporter. In this embodiment, EX-1 50 is an extruder, such as a devolatilizing extruder, of sufficient capacity and function to shape the extrudate into the desired shapes with the desired dimensions. This extruder may include temperature and pressure controls for the precise control of the temperature and pressure in portion of the extruder and/or throughout the entire extruder. For instance, the extruder may be specifically designed to remove liquids from the denser, extrudable material. In some embodiments, the extruder can perform both temperature/pressure control and liquid removal. In this embodiment, the polymeric solution is transported from the output of OV-1 40 to EX-1 50 by transporter means 42 utilizing pressure. Once the polymeric gel is extruded and sized, it is conveyed or otherwise fed into the pyrolysis furnace.

In another embodiment, both the drying and extrusion step is performed in the extruder, such as in a devolatilizing extruder, of sufficient capacity and function to shape the extrudate into the desired shapes with the desired dimensions. As such, the polymeric gel is dried and fully cured by the completion of the extrusion process.

### Pyrolysis

Following extrusion, the extruded polymeric gel is subjected to high heat for the production of the carbon monolith/pellets/extrudates/beads. While the process provided herein encompasses the use of combustion and/or pyrolysis to administer the high heat to be applied to the extruded polymeric gel to produce the final porous carbon materials, it is preferable to utilize pyrolysis. The flow of inert gases may be used to produce an inert atmosphere that favors pyrolysis over combustion at high temperatures. For instance, in an embodiment, the flow of inert gas, such as nitrogen gas, argon gas, or helium gas, may be used to maintain an inert atmosphere within a kiln or furnace during pyrolysis. Suitable equipment/devices for pyrolysis include kilns, ovens, furnaces, or pyrolysis chambers known in the art. In a particular embodiment, a specially designed furnace is used that can vary temperature, pressure, and residence time within the furnace to accomplish the pyrolysis.

For the pyrolysis step, the extruded polymeric carbon gel material should be transported as soon as possible to equipment or device(s) designed for the purpose of heating the material in the absence of oxygen to a temperature of greater than 500° C., e.g., 501° C., 510° C., 520° C., 530° C., 540° C., 550° C., 560° C., 570° C., 580° C., 590° C., 600° C., 610° C., 620° C., 630° C., 640° C., 650° C., 660° C., 670° C., 680° C., 690° C., 700° C., 710° C., 720° C., 730° C., 740° C., 750° C., 760° C., 770° C., 780° C., 790° C., 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C., 1,000° C., 1,050° C., 1,100° C., 1,150° C., 1,200° C., 1,250° C., 1,300° C., 1,350° C., 1,400° C., or greater, until the material is fully carbonized. Preferably, the temperature is in the range from about 500° C. to about 1,300° C.; more preferably, between about 600° C. and 1,000° C. For instance, in one particular embodiment, the temperature for pyrolysis is about 800° C. In another embodiment, the temperature for pyrolysis is as high as about 1,200° C.

The residence time for pyrolysis can range from about 10 minutes to about 14 hours, e.g., 10 minutes, 15 minutes, 20 minutes, 25 minutes, 30 minutes, 45 minutes, 1 hour, 1.5 hours, 2 hours, 2.5 hours, 3 hours, 3.5 hours, 4 hours, 4.5 hours, 5 hours, 5.5 hours, 6 hours, 6.5 hours, 7 hours, 7.5 hours, 8 hours, 8.5 hours, 9 hours, 9.5 hours, 10 hours, 10.5 hours, 11 hours, 11.5 hours, 12 hours, 12.5 hours, 13 hours, 13.5 hours, or 14 hours. In a preferred embodiment, the residence time is about 1 hour to about 12 hours. This step, in particular, removes all remaining substances with the exception of carbon to result in a hierarchically porous carbon material. The removed material may be collected and re-used in this process, thermally decomposed, or otherwise discarded as waste.

As represented by FIG. 2, the extruded polymeric gel is transported from EX-1 50 to the pyrolysis furnace RX-2 60 via conventional transporter member 52. Pyrolysis furnace RX-2 60 is utilized to pyrolyze the cured and dried extrudates. In the embodiment shown in FIG. 2, the pyrolysis furnace RX-2 60 is maintained in the absence or near absence of oxygen (or other oxidant gases) to prevent combustion. In this embodiment, the extrudate is pyrolyzed under nitrogen gas at a temperature of about 800° C. with a residence time of about 10 hours.

In some embodiments, the hierarchically porous carbon material produced by the pyrolysis step can be in the form of a monolith. In other embodiments, the hierarchical porous carbon material produced by the pyrolysis step can be cut or ground into any desirable shape or form. For instance, the activated carbon material can be ground up into small particles of less than about 0.1 mm in diameter (e.g., a powder).

This innovative process is especially amenable to automation, either specific steps or the entire process. All process steps of the method provided herein are continuous and can be automated, requiring very little, if any, process interruption by operators, only requiring monitoring by means of computer or PLC panel. Thus, provided herein is an innovative method for the continuous production of hierarchically porous carbon materials. Indeed, the process described herein provides for a continuous process from beginning and to end of the polymeric self-assembly reaction; the removal of solvents and water from the material to a specified recovery (measured as the recovered water/solvent amount divided by the beginning water/solvent amount); the sizing and shaping of the polymeric material in order to retain the desired hierarchically porous structure; optionally, the further drying of the shaped and sized polymeric material; and the pyrolysis of the polymeric material into a monolithic, hierarchically porous carbon material of characterized and uncharacterized pore structure, diameter, and distribution.

The following examples are provided to describe the invention in greater detail. They are intended to illustrate, not to limit, the invention.

### Example 1: Batch Production of the Hierarchically Porous Carbon Pellets (Stamp-Molding)

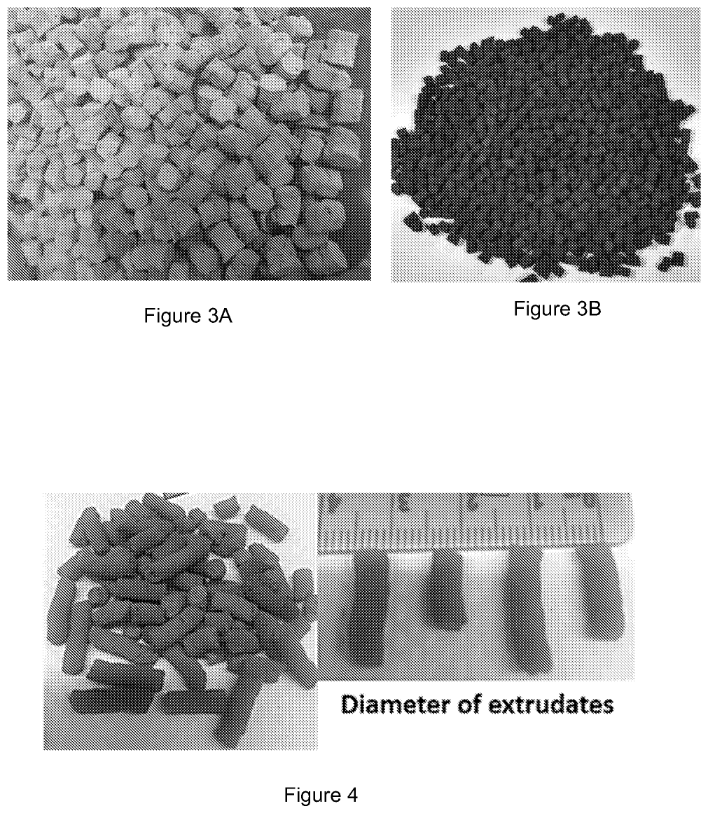

At room temperature, resorcinol, poloxamer 407, ethanol and water were added to a 100 liter mixing tank in 9 kg, 3.3 kg, 27 kg, and 27 kg quantities, respectively. The mixture was stirred until the solid components were fully dissolved. To this mixture, 0.25 kg of 1,6-diaminohexane was added while stirring and allowed to dissolve. Next, 15 kg of formalin was added and stirred for 20 minutes. The solution was pumped into trays and heated to 70° C. for 8 hours. After 8 hours, the gel was stamped with a honeycomb mold and the resulting polymer was dried overnight at 55° C. As shown in FIG. 3, these polymer pellets (FIG. 3a) were then pyrolyzed at 800° C. under nitrogen flow for 2 hours (FIG. 3b). The average nitrogen sorption surface area of the 10 samples measured from this batch was 600 m²/g.

### Example 2: Batch Production of the Hierarchically Porous Carbon Extrudates (Extrusion)

At room temperature, resorcinol, poloxamer 407, ethanol and water were added to a 1 liter beaker in 115 g, 41.75 g, 343.5 g, and 343.5 g quantities, respectively. The mixture was stirred until the solid components were fully dissolved. To this mixture, 3 grams of 1,6-diaminohexane was added while stirring and allowed to dissolve. Next, 170 g of formalin was added and stirred for 10 minutes. The solution was poured into a tray and heated to 80° C. for 10 hours after which the heat was reduced to 55° C. for 10 hours. The gel was then fed into the hopper of a single screw, low sheer extruder and extruded at a rate of 30 grams per minute. FIG. 4 shows the resulting extrudates prior to pyrolysis. These polymer extrudates were then pyrolyzed at 800° C. under nitrogen flow for 2 hours. The average nitrogen sorption surface area of the 10 samples measured from this batch was 580 m²/g.

### Example 3: Batch Production of Hierarchically Porous Carbon Using Lysine as Primary Amine

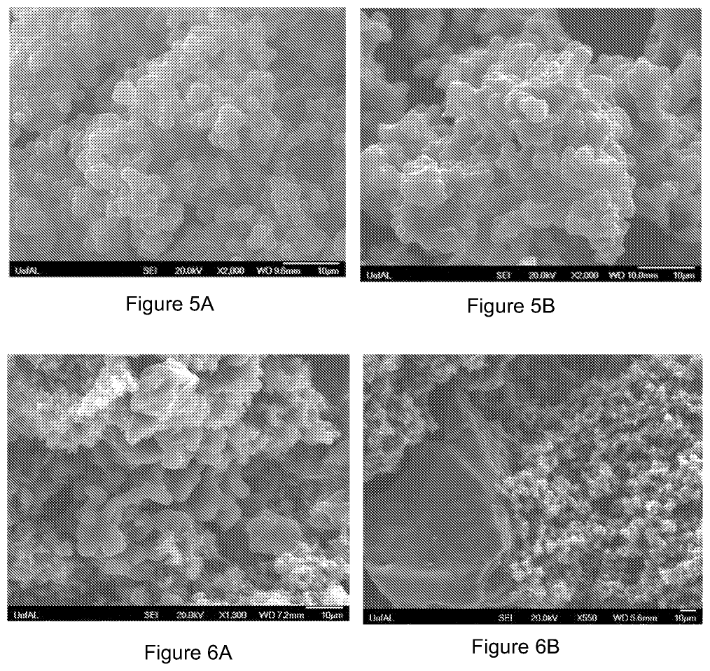

At room temperature, resorcinol, poloxamer 407, ethanol and water were added to a 100 mL mixing vessel in 9 g, 3.75 g, 54 g, and 54 g quantities, respectively. This mixture was stirred until the solid components were fully dissolved. To this mixture, 0.9 g of lysine was added while stirring and allowed to dissolve. Next, 13.3 g of formalin was added and stirred for 20 minutes. The polymeric solution was transferred to trays and heated to 80° C. for 4 hours. The gel was stamped using the honeycomb mold and dried overnight at 55° C. for 12 hours. The polymer pellets were then pyrolyzed at 800° C. under nitrogen flow for 2 hours. FIG. 5 shows an SEM image of a hierarchically porous carbon monolith produced from this continuous production method. The average nitrogen sorption surface area of carbon produced from this batch was 550 m²/g.

### Example 4: Batch Production of Hierarchically Porous Carbon Using Commercial Carbon as Binder for Extrusion

At room temperature, resorcinol, poloxamer 407, ethanol and water were added to a 100 mL mixing vessel in 9 g, 3.75 g, 20 g, and 20 g quantities, respectively. This mixture was stirred until the solid components were fully dissolved. To this mixture, 0.234 g of 1,6 diaminohexane was added while stirring and allowed to dissolve. Next, 13.3 g of formalin was added and stirred for 20 minutes. Activated carbon (1.13 g) (Calgon Carbon Corporation, Moon Township, Pa., United States) was added to the polymeric solution and the resulting solution was transferred to trays and heated to 80° C. for 10 hours. The cured gel was dried overnight at 55° C. for 10 hours and the resulting polymer was extruded using a single screw extruded at a rate of 30 grams per minute capacity. The polymer extrudates were then pyrolyzed at 800° C. under nitrogen flow for 2 hours. FIG. 6 shows an SEM image of a hierarchically porous carbon monolith produced from this production method.

### Example 5: Semi-Continuous Production of Hierarchically Porous Carbon

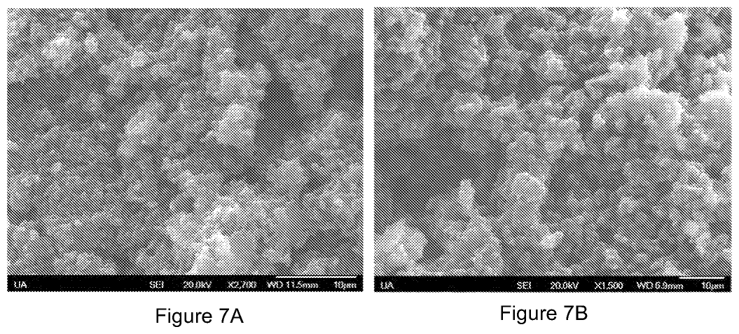

At room temperature, resorcinol, poloxamer 407, ethanol and water were added to a 100 liters mixing tank in 9 kg, 3.3 kg, 27 kg, and 27 kg quantities, respectively. This mixture was stirred until the solid components were fully dissolved. To this mixture, 0.25 kg of 1,6-diaminohexane was added while stirring and allowed to dissolve. Then, 13.4 kg formalin was added to initiate the polymerization. This mixture was then pumped into a plug flow reactor. This material was heated to 82° C. within the reactor with constant flow rate of 1.4 kg per hour for curing. Devices were applied to the plug-flow reactor to maintain a constant pressure of about 0 to 1 bar (about 0 to about 14.5 psi) throughout the reactor. The cured polymeric gel was poured into trays and heated for 10 hours at 60° C. for drying to remove excess solvent like water, ethanol and unreacted formalin. The gel was then fed into the hopper of a single screw, low sheer extruder and extruded at a rate of 30 grams per minute. These polymer extrudates were then pyrolyzed at 800° C. under nitrogen flow for 2 hours. The average nitrogen sorption surface area of the 10 samples measured from this batch was 700 m²/g. FIG. 7 shows an SEM image of a hierarchically porous carbon monolith produced from this production method.

### Example 6: Continuous Production of Hierarchically Porous Carbon

At room temperature, resorcinol, poloxamer 407, ethanol and water were added to a 100 liter mixing tank in 9 kg, 3.3 kg, 27 kg, and 27 kg quantities, respectively. This mixture was stirred until the solid components were fully dissolved. To this mixture, 0.25 kg of 1,6-diaminohexane was added while stirring and allowed to dissolve. This mixture was then pumped into a plug flow reactor where 13.4 kg formalin was added in-line to the main flow of the reactor. This material was then heated to 120° C. within the reactor for about 20 minutes to allow the product gel to be produced. Devices were applied to the plug-flow reactor to maintain a constant pressure of about 0 to 1 bar (about 0 to about 14.5 psi) throughout the reactor and discharge into a de-volatilizing extruder feed port.

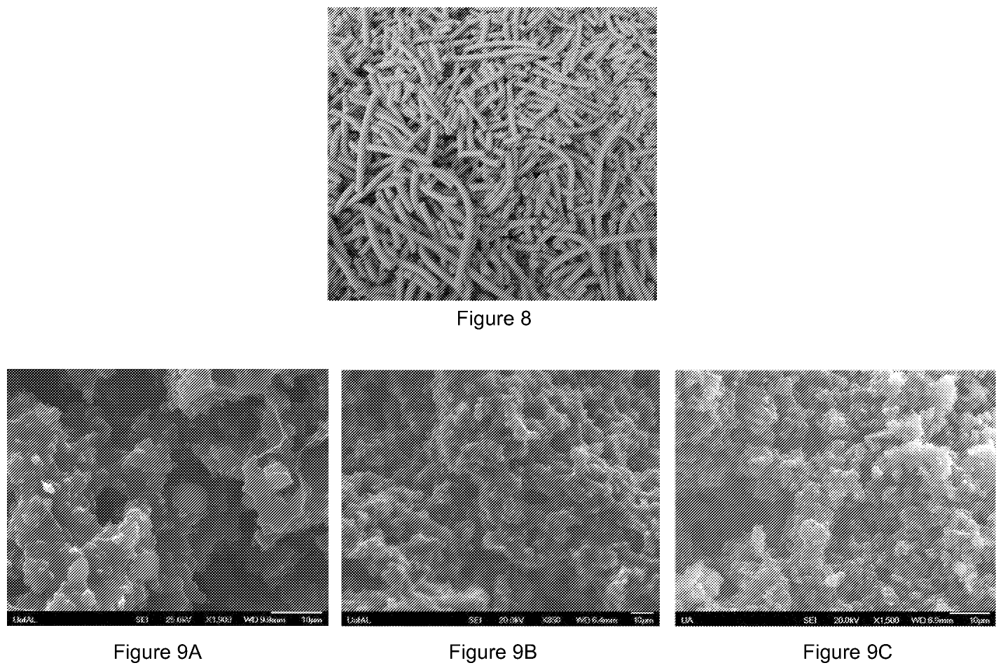

From here, the material was further mixed, cured, and dried. Excess solvents were removed in specific zones by manipulating pressure and temperature conditions experienced by the material within these zones. Specifically, the material was mixed at ambient temperature for about 1 minute and dried at a temperature range of between about 78° C. and 82° C. with a residence time of about 20 minutes, and then cooled for about 1 minute. The extruder then applied hydraulic pressure to the gel against a die-face with cylindrical bore holes. The material exiting the die face was then cut after the desired length was achieved and dropped onto a conveyer. The conveyer carried the polymer extrudates (see FIG. 8) into the inlet of a pyrolysis furnace, where the material was pyrolyzed at 800° C. under a nitrogen environment. The pyrolysis furnace was sized such that the material had a residence time of 1 hour within the furnace at these conditions. The average nitrogen sorption surface area of the 10 samples measured from this batch was 655 m²/g.

FIG. 9C shows an SEM image of a hierarchically porous carbon monolith produced from this continuous production method. The porosity of the hierarchically porous carbon monoliths produced by this continuous process is comparable to the carbon monoliths produced by the batch production methods set forth in Examples 1 and 2 (see FIGS. 9A-9C).

1. A method of producing a porous carbon material comprising:
(a) providing carbon in the form of a phase-homogenous polymeric mixture;
(b) reacting the phase-homogeneous polymeric mixture at a first temperature and for a first period of time, wherein the first temperature is in a range from about 40° C. to about 130° C. and the first period of time is about 1 minute to about 60 minutes, and wherein the phase-homogeneous polymeric mixture self-assembles to form a polymeric gel;
(c) drying the polymeric gel at a second temperature for a second period of time to produce a dried polymeric gel, wherein the second temperature is in the range from about 40° C. to about 140° C. and the second period of time is about 1 minute to about 12 hours;
(d) shaping the dried polymeric gel to produce a shaped polymeric gel; and
(e) pyrolyzing the shaped polymeric gel at a third temperature for a third period of time to produce the porous carbon material, wherein the third temperature is in the range from about 500° C. to about 1,300° C. and the third period of time is about 10 minutes to about 12 hours.

2. The method of claim 1, wherein steps (b)-(d) are performed as an automatic, continuous process or wherein steps (b)-(e) are performed as an automatic, continuous process.

3. (canceled)

4. The method of claim 1, wherein a mixing step is performed prior to reacting the phase-homogeneous polymeric material, the mixing step comprising mixing an organic polymer composition to produce the phase-homogeneous polymeric mixture.

5. (canceled)

6. The method of claim 1, wherein the reacting step further comprises the addition of an initiator compound and reacting the phase-homogeneous polymeric mixture in a reactor, wherein the reactor is a plug-flow reactor or a tube-in-tube heat exchanger.

7. (canceled)

8. The method of claim 6, wherein the initiator compound is an aldehyde.

9. (canceled)

10. The method of claim 1, wherein the phase-homogeneous polymeric mixture comprises a self-assembling thermoset polymer composition.

11. The method of claim 10, wherein the self-assembling thermoset polymer composition comprises:
(i) an amine;
(ii) an aldehyde as an initiator compound; and
(iii) a phenolic compound.

12. The method of claim 11, wherein the self-assembling thermoset polymer composition further comprises a surfactant, pore-forming solid, a solvent, or any combination thereof.

13. The method of claim 11, wherein:
(i) the amine is a primary amine;
(ii) the aldehyde is formaldehyde, trioxane, butyraldehyde, or benzaldehyde; and
(iii) the phenolic compound is a benzenediol or phenol.

14. The method of claim 13, wherein the primary amine is 1,6-diaminohexane or lysine, and wherein the benzenediol is 1,3-benzenediol.

15-18. (canceled)

19. The method of claim 1, wherein the shaping step further comprises injection molding, pour molding, casting, extrusion, or extrusion-spheronization.

20. The method of claim 19, wherein the shaping step comprises extrusion and an extruder for extruding the dried polymeric gel.

21. The method of claim 20, wherein the extruder is selected from the group consisting of a screw extruder, a food extruder, a sieve extruder, a basket extruder, a roll extruder, a ram extruder, a pressure extruder, a hydraulic extruder, and a devolatilizing extruder.

22. The method of claim 21, wherein steps (c) and (d) are performed in an extruder, and wherein the extruder is a devolatilizing extruder configured to dry the polymeric gel and extrude the dried polymeric gel.

23. The method of claim 1, wherein the porous carbon material is a hierarchical porous carbon material.

24. The method of claim 1, wherein:
the first temperature is from about 60° C. to about 100° C., and the first period of time is from about 1 minute to about 10 minutes;
the second temperature is from about 75° C. to about 140° C., and the second period of time is from about 1 minute to about 10 minutes; and/or
the third temperature is from about 600° C. to about 1,000° C.

25-30. (canceled)

31. A continuous process for producing a hierarchical porous carbon material comprising:
(a) providing an organic thermoset polymer composition, wherein the organic thermoset polymer composition is capable of self-assembling when reacted in the presence of an initiator compound at a first temperature in the range from about 40° C. to about 130° C. and for a first period of time;
(b) mixing the organic thermoset polymer composition to produce a phase-homogeneous polymer mixture;
(c) reacting the phase-homogeneous polymer mixture at the first temperature and for the first period of time to produce a polymeric gel;
(d) drying the polymeric gel at a second temperature in the range from about 40° C. to about 140° C. for a second period of time to produce a dried polymeric gel, wherein the second period of time is about 1 minute to about 12 hours;
(e) extruding the dried polymeric gel to produce an extruded polymeric gel; and
(f) pyrolyzing the extruded polymeric gel at a third temperature in the range from about 500° C. to about 1,300° C. for a third period of time to produce a porous carbon material, wherein the third period of time is about 10 minutes to about 12 hours; and
wherein steps (b)-(e) are performed as an automatic, continuous process.

32. The continuous process of claim 31, wherein steps (b)-(f) are performed as an automatic, continuous process.

33. (canceled)

34. The continuous process of claim 31, wherein steps (d) and (e) are performed in a single device.

35. The continuous process of claim 31, wherein the reacting step (c) further comprises a reactor selected from the group consisting of a plug-flow reactor, a tube-in-tube heat exchanger, and a tube-in-shell heat exchanger.

36. The continuous process of claim 35, wherein the reactor is a plug-flow reactor configured to inject the initiator compound into the phase-homogeneous polymer mixture during the reacting step to initiate self-assembly of the phase-homogeneous polymer mixture.

37. The continuous process of claim 31, wherein the extruding step (e) further comprises an extruder for extruding the dried polymeric gel to produce the extruded polymeric gel, wherein the extruder is selected from the group consisting of a screw extruder, a food extruder, a sieve extruder, a basket extruder, a roll extruder, a ram extruder, a pressure extruder, a hydraulic extruder, and a devolatilizing extruder.

38. (canceled)

39. The continuous process of claim 37, wherein the extruder is a devolatilizing extruder further configured to dry the polymeric gel and to extrude the dried polymeric gel.

40. The continuous process of claim 31, wherein the initiator compound is an aldehyde and wherein the organic thermoset polymer composition further comprises an amine, a compound comprising a carbonyl group or an aromatic ring, and a solvent.

41. (canceled)

42. The continuous process of claim 31, wherein the initiator compound is formaldehyde and the organic thermoset polymer composition comprises:
(a) 1,6-diaminohexane and 1,3-benzenediol;
(b) a surfactant or a pore-forming solid; or
(c) both (a) and (b).

43. (canceled)

44. The continuous process of claim 31, wherein the porous carbon material comprises:
a plurality of macropores defined by a wall, wherein the macropores have a diameter of from about 0.05 μm to about 100 μm, wherein the walls of the macropores comprise a plurality of mesopores defined by a wall, wherein the mesopores have a diameter of from about 2 nm to about 50 nm, and wherein the walls of the macropores and mesopores comprise a continuous carbon phase.

45. The continuous process of claim 31, wherein:
(a) the first temperature is about 60° C. to about 100° C., and the first period of time is from about 1 minute to about 10 minutes;
(b) the second temperature is from about 75° C. to about 140° C., and the second period of time is from about 1 minute to about 10 minutes; and/or
(c) the third temperature is from about 600° C. to about 1,000° C.

46. (canceled)

47. The continuous process of claim 31, wherein the pyrolysis step (f) comprises pyrolysis under an inert atmosphere, wherein the inert atmosphere comprises nitrogen and is substantially devoid of oxygen.
